(19) United States
(12) Patent Application Publication
(10) Pub. No.: US 2025/0040635 A1
(43) Pub. Date: Feb. 6, 2025

(54) HEAD SUPPORT FOR A VISOR

(71) Applicant: Mestemacher Innovation GmbH, Fehmarn (DE)

(72) Inventor: Sönke Mestemacher, Fehmarn (DE)

(21) Appl. No.: 18/720,213

(22) PCT Filed: Dec. 8, 2022
(86) PCT No.: PCT/DE2022/000119

§ 371 Date: Jun. 14, 2024

(30) Foreign Application Priority Data
Dec. 18, 2021 (DE) 20 2021 003 824.8
Apr. 11, 2022 (DE) 10 2022 001 224.3
Aug. 9, 2022 (DE) 10 2022 002 881.6

(51) Int. Cl. A41D 13/11; A41D 13/002

(52) U.S. Cl. CPC A41D 13/1184; A41D 13/0025; A41D 13/1161

(57) ABSTRACT

A head support configured to be worn on the head of a wearer includes a visor and a headband. The headband includes a front portion and a pair of branch portions. The branch portions extend transversely away from the front portion and each includes a downward extension portion. The visor extends in curved contacting relation with the headband. A pair of fans with counterrotating fan blades cause air to move through the headband and into an area between the visor and the face of the wearer.

### TECHNICAL FIELD

Exemplary arrangements relate to a head support with a visor. Exemplary arrangements relate to such head supports which are worn on or around a head of the wearer and which may be used as personal protective equipment.

### BACKGROUND

Head supports with visors are known to be worn on or around a wearer's head. Such head supports may be useful for purposes of protecting the wearer from exposure to contaminants while enabling the wearer to view their surroundings through a transparent visor.

An example of a known head support with a visor is shown in WO 2021/233488 A1 which corresponds to US Patent Publication 2023/0191169 the disclosure of which is incorporated herein by reference in its entirety. The headband of this arrangement allows a technical infrastructure to be accommodated in the head support, and a visor to be attached to the latter.

Such head supports are usable as protective devices that are worn on, or around, the head, and fall into the category of personal protective equipment and medical devices. They serve to protect people from airborne biological and chemical contaminants. However, they are also suitable for other applications.

Known head supports have limitations and often have drawbacks in performance and/or use. Such head supports may benefit from improvements.

### SUMMARY

Exemplary arrangements relate to a head support with a visor which may be alternatively referred to as a face shield, that can be worn continuously with a high level of comfort, so as to increase the level of protection without the need for a complex design that restricts freedom of movement.

Exemplary arrangements include a head support with a transparent visor. The head support includes a headband which has a front portion extending in an x-axis direction. The exemplary head support further includes two branch portions. The branch portions extend at generally right angles to the front portion in a z-axis direction that is perpendicular to the x-axis direction. In the exemplary arrangement the headband extends in a plane that extends in both the x-axis direction and the z-axis direction. The exemplary headband further includes a pair of extension portions. Each extension portion extends away from a respective branch portion in a y-axis direction that is perpendicular to each of the x-axis direction and the z-axis direction. Each extension portion includes a respective contact surface portion. The exemplary visor is in attached connection with the headband and extends in curved relation in engagement with the front portion and each of the branch portions, and is in attached connection with the respective contact surface portion of each respective extension portion. It should be understood that when used herein a reference to an axis direction (e.g. x-axis direction or the direction of the x-axis, etc.) does not refer to just along a linear axis such as shown in FIG. 3 for example, but also refers to a direction that is parallel to the respective linear axis.

In some arrangements the extension portion described can also be used independently of the type and shape of the headband, in particular with regard to further configurations and can be used for other visor supports.

The extension portions make it possible to attach a visor to the latter that is curved towards the face of the wearer. When using planar flat flexible visors, these can be curved, and the extension portions attached to both sides of the visor so that the headband can hold the visor in its curved shape.

The extension portions may be hollow and/or include one or more cavities, such that insulating materials, electronic components, or air filters, can be arranged in the latter. Circuit boards, batteries, switches, or headphones, can, for example, be integrated as electronic components in the extension portions. This leads to the implementation of compact integrated designs and an optimum weight distribution for the head support.

The extension portions can also be configured such that each rests against the headrest, when the head is leant against the headrest. The extension portions may also move the center of gravity of the head support downwards towards the extension portion, in the direction of the z-axis.

In addition, in some arrangements, microphones, or suction devices, can also be arranged on the extension portions.

In some arrangements at least one motorized fan is arranged in the headband. In such arrangements, the extension portions may protect the wearer of the headband from sound and vibrations. This may be true in particular arrangements when the fan is arranged on a rear face of the headband facing away from the curved front part of the headband.

In an exemplary arrangement the extension portion has a length of between 3 cm and 20 cm in the x-axis direction, and preferably of about 8 cm. In the z-axis direction, it has a width of between 0.2 cm and 6 cm, and preferably of about 2.5 cm. It is also useful in some arrangements if the extension portion in the x-axis direction has a depth of between 0.5 cm and 8 cm, and preferably of about 4 cm. A downwardly narrowing conical design ensues when the shape of at least one of the extension portions tapers down from the band in the y-axis direction. This results in an ergonomic and stable shape of the head support.

In some arrangements it is useful if at least one of the extension portions has a cushion that faces in the direction of the x-axis towards the opposing extended portion. The cushion serves to provide contact with the wearer's head, and should therefore be embodied in a skin-friendly manner. The cushion can also be sound-absorbing. On the one hand, it can be designed to be very soft, so as to close a space between the extension portion and the head, without exerting a pressure on the head. On the other hand, however, it can also be embodied in a plastic and preferably elastically deformable manner, such that the extension portion also enables a secure positioning of the head support on the head.

In addition, an extension portion, in particular with a cushion, can implement a transfer of forces from the head support to the head in a vibration-damping manner.

In some arrangements it is useful if an airtight closure is achieved between the opposing extension portions and the wearer's head. This can also be achieved using cushions specially designed for this purpose.

It is useful in exemplary arrangements if the head support has a visor, which is at least also attached to contact surfaces of the extension portions. The extension portions thus form a shaping support structure for the attachment of the visor.

The shape of the visor can be determined by means of the extension portions. Depending on the arrangement of the extension portions, and, in particular, of the contact surfaces of the extension portions, a visor that is attached to the latter, which can be supplied as a flexible planar flat panel, can receive a special predetermined shape when in use.

For this purpose, in some arrangements the contact surfaces may lie in a plane which, pivoted about a z-axis direction, extends in the direction of the x-axis at an angle α of approximately 5 to 25 degrees towards the opposing extended portion, angled towards a plane in the directions of the y- and z-axes. A visor curved in a U-shape in cross-section, in accordance with a curved headband, can thus be pulled towards the head in a lower contact region on the extension portions, remote from the headband, and thus does not extend vertically in the contact region on the extension portions, but rather is curved inwards by the angle α.

The visor can also be curved slightly downwards from the curved contact surface on the headband, towards the wearer's face. This describes an angle β, which is formed between the front visor surface or leading portion of the visor in the center of the headband, and a lower region of the visor that is angled downwards. For this purpose, the contact surfaces may lie in a plane which, when pivoted about a y-axis, extends in the direction of the x-axis by an angle β of approximately 5 degrees to 25 degrees towards the extended portions, angled towards a plane in the directions of the x- and z-axes.

The extension portions may absorb the forces resulting from the shaping of the visor.

In some arrangements to achieve a good and secure contact between the visor and the extension portions, the contact surfaces have a bead or a step, against which the visor rests. By this means a particularly flush fit of the visor on the extension portion can be achieved. This makes it easily possible to resist air flow and prevent air from escaping or entering from the visor sides.

In some arrangements specially shaped visors can be used for exemplary head supports. However, in some arrangements it is useful to use simple, flat planar flexible visors. These are only shaped when they are attached to the headband and the extension portions, and are held in a desired shape in particular by the attachment to the extension portions.

In some arrangements independently of the headband, exemplary extension portions can also be attached to a plurality of different head supports with a visor or a face shield. These include construction helmets, caps, welding helmets, and other forms of headgear. Here the headband can, for example, be designed to be U-shaped, oval, or also as part of a cap.

Even in arrangements with no extension portions arranged on the headband, it is may be useful if the visor is flat when not attached to the headband, and has a curved upper face when in the contact region on the headband. The curve on the upper face of the visor, which serves as a face shield, results in a downwardly tapering shape toward the face of the wearer when attached to the headband, although the visor is flat when not in the curved state, and is therefore easy to manufacture.

It may be useful in some arrangements that a large volume of air can flow through the headband with minimum flow resistance, in order that the air can be filtered in the headband. For this reason, in some arrangements of headbands either with or without extension portions, the headband may have an upper face that has a crescent shape air intake surface. This makes it possible to use almost the entire upper face of the headband as an intake surface, in order to have a cross-section that is as large as possible for the entry of the air, which only minimally impairs the air flow. Further details of exemplary arrangements are shown and described in the following Detailed Description.

### BRIEF DESCRIPTION OF DRAWINGS

FIG. 1 shows a view from the front of an exemplary head support with extension portions on both sides.

FIG. 2 shows a view directly from the front of the head support shown in FIG. 1.

FIG. 3 shows the orthogonal reference system to explain the directions of the axes in FIGS. 1 and 2, where the z-axis direction extends at right angles to the plane of the paper.

FIG. 4 shows a side view of the head support with a visor that is shown in FIGS. 1 and 2.

FIG. 5 shows a side view of the head support shown in FIG. 4.

FIG. 6 shows the reference system for the views shown in FIGS. 4 and 5, where the x-axis direction extends at right angles to the plane of the paper.

FIG. 7 shows a cross-sectional view through the extension portion in taken along the line 7-7 in FIG. 5.

FIG. 8 shows a top perspective view from above of a first alternative arrangement of a head support.

FIG. 9 shows a frontal view of the alternative head support shown in FIG. 8.

FIG. 10 shows a side view of the head support shown in FIG. 8.

FIG. 11 shows a perspective side view of a second alternative arrangement of a head support with a peripheral visor edge.

FIG. 12 shows a frontal view of the alternative arrangement shown in FIG. 11.

FIG. 13 shows an enlarged cross-section through the edge of the visor along the line 13-13 in in FIG. 12.

FIG. 14 shows a perspective side view of a further alternative arrangement of a head support with a peripheral visor edge.

FIG. 15 shows a frontal view of the arrangement shown in FIG. 14.

FIG. 16 shows an enlarged cross-section through the edge of the visor along the line 16-16 in FIG. 15.

FIG. 17 shows a perspective side view of a further alternative arrangement of a head support with a peripheral visor edge.

FIG. 18 shows a frontal view of the arrangement shown in FIG. 18.

FIG. 19 shows an enlarged cross-section through the edge of the visor along the line 19-19 in FIG. 18.

FIG. 20 shows a perspective side view of a further alternative arrangement of a head support with a peripheral visor edge.

FIG. 21 shows a frontal view of the arrangement shown in FIG. 21.

FIG. 22 shows an enlarged cross-section through the edge of the visor along the line 22-22 in FIG. 21.

FIG. 23 shows a perspective side view of a further alternative arrangement of a head support with a peripheral visor edge.

FIG. 24 shows a frontal view of the arrangement shown in FIG. 24.

FIG. 25 shows a cross-section through the edge of the visor along the line 25-25 in FIG. 24.

FIG. 26 shows a frontal view of a further alternative arrangement of a head support with a peripheral visor edge.

FIG. 27 shows an enlarged cross-section along the line 27-27 in FIG. 26.

FIG. 28 shows an enlarged cross-section along the line 28-28 in FIG. 26.

FIG. 29 shows a plan view onto an exemplary visor for a head support in accordance with FIGS. 1 to 11.

FIG. 30 shows a plan view onto a visor for a head support in accordance with FIGS. 12 to 28.

FIG. 31 shows a top plan view of an exemplary head support.

FIG. 32 shows a frontal view of the head support shown in FIG. 31.

FIG. 33 shows a view of the flow conditions on the exemplary head support.

FIG. 34 shows a plan view onto an alternative head support.

FIG. 35 shows a cross-sectional view through the head support along line 35-35 in FIG. 34.

FIG. 36 shows a frontal view of the head support shown in FIG. 34 and air flow proved thereby.

FIG. 37 shows a view of a head support with fans arranged side by side.

FIG. 38 shows a view of a head support with air filters.

FIG. 39 shows a view from the rear of a visor with sound absorbers.

FIG. 40 shows a view from above of the visor shown in FIG. 39 in the mounted state.

FIG. 41 shows an oblique view from below of the visor shown in FIG. 39.

FIGS. 42 to 46 show the air flow through the headband.

FIGS. 47 to 50 show an exemplary construction of the headband.

FIGS. 51 to 55 show the attachment of a curved visor to the headband.

FIGS. 56 to 60 show an exemplary process of hooking the visor onto the headband.

FIGS. 61 to 63 show the interrelationship of the headband with electronic instruments.

### DETAILED DESCRIPTION

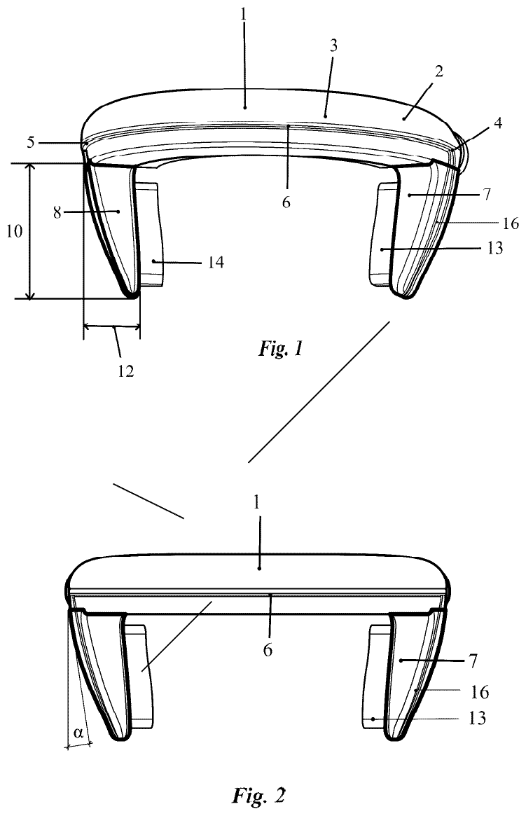

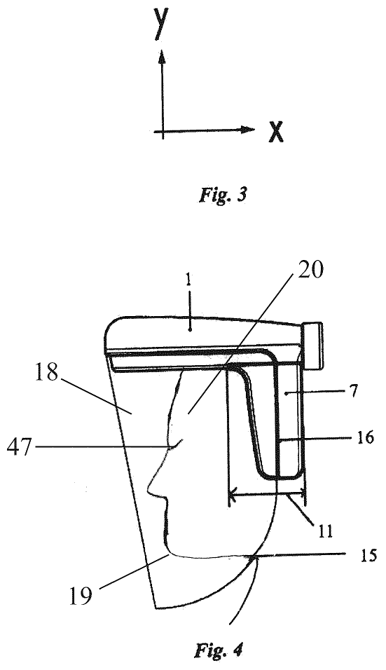

The exemplary head support 1 shown in FIG. 1 has a headband 2, which has a curved region 3 that is alternatively referred to as a front portion, extending in the direction of the x-axis. The headband includes two branch regions 4 and 5 that are alternatively referred to as branch portions. The exemplary branch portions extend at right angles to the front portion in the direction of the z-axis. The headband thus lies in an x-z plane 6. At right angles to this x-z plane 6, extension portions 7 and 8 extend downward along the branch regions 4 and 5 of the headband 2 in the direction of the y axis. The extension portions are alternatively referred to herein as extended portions.

The exemplary extended portions 7 and 8 in each case have an internal cavity 9, in which are arranged electronic components and/or air filters (not shown).

Each exemplary extended portion has a length 10 of approximately 8 cm, a width 11 in the direction of the z-axis of approximately 2.5 cm, and a depth 12 in the direction of the x-axis of approximately 4 cm.

In the exemplary arrangement the width 11 and depth 12 taper in the direction of the y-axis, away from the band and towards the lower end of the extended portion.

In each case the two extended portions have a cushion 13 or 14 in the direction of the x-axis facing towards the opposing extended portion. This cushion is made of an elastic foam material, which fills the space between the extended portion and the head 20 of a wearer of the head support.

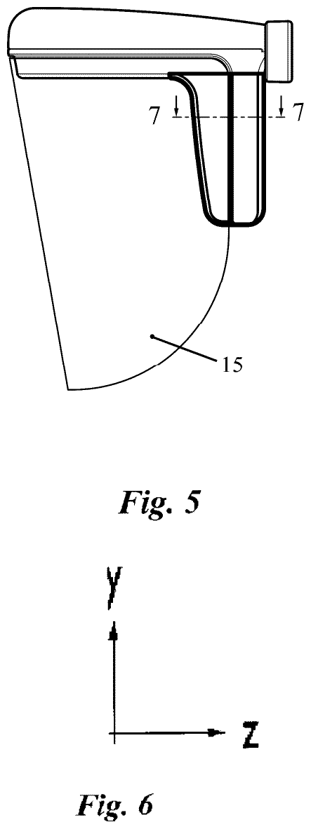

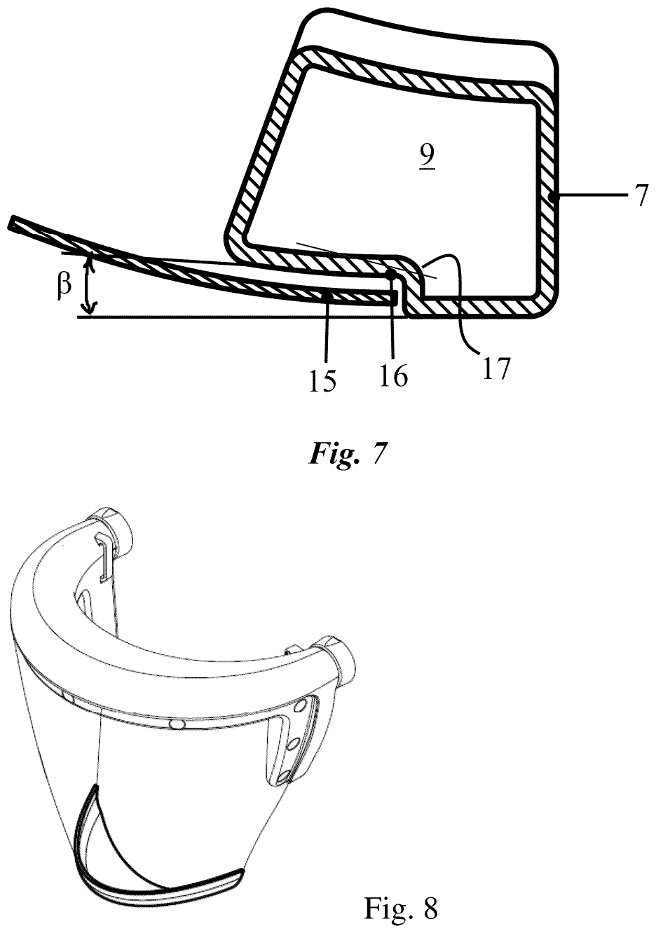

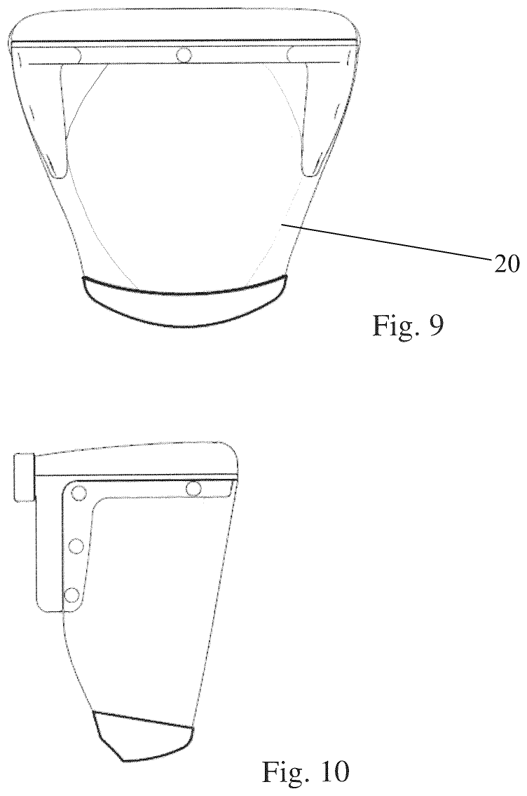

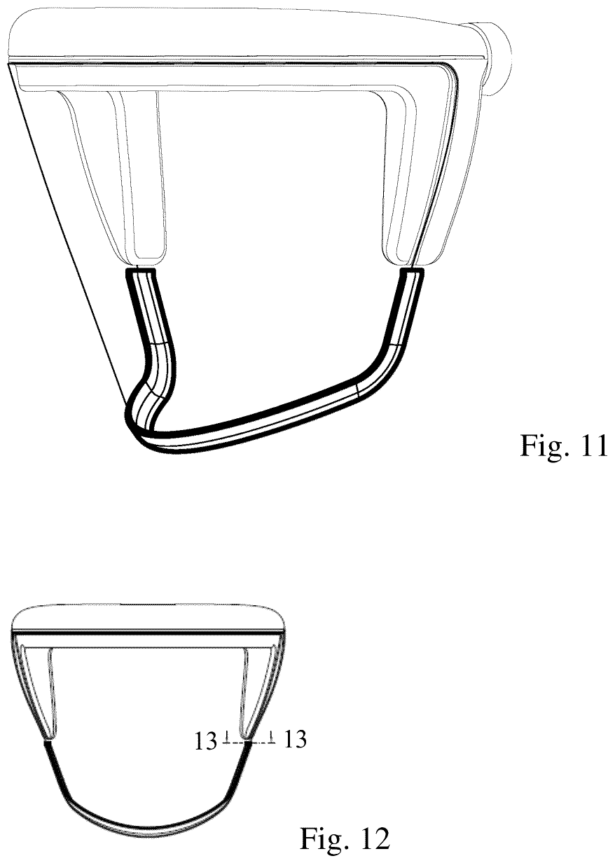

FIGS. 4, 5 and 7 show the visor 15, which is curved around the headband 2, and rests against and is in attached connection with contact surfaces 16 on the extended portions 7, 8 which in the operative position extend downward from branch regions 4 and 5 as shown. Contact surfaces 16 are alternatively referred to herein as contact surface portions.

The exemplary contact surfaces 16 are curved such that the visor 15 is curved at an angle α towards the wearer's face 19 and head 20, and rests against the contact surface 16 at a slight inclination, in accordance with the angle β, from a plane in the directions of the x- and z-axes.

A step 17 is provided on the extended portion 7 in the contact region 16. This facilitates the contact of the visor 15 with the contact surface 16, which restricts airflow and ensures a seal that is as airtight as possible.

The other Figures show alternative forms of exemplary arrangements with differently shaped visors, contact surfaces on the extended portions, a contact surface on the headband, and a contact surface on a band holder. On the one hand, the band holder serves to direct the airflow from the visor to the visor wearer. On the other hand, the band holder can also hold the visor in a curved shape if it is not already held in an optimally curved shape by the other contact surfaces.

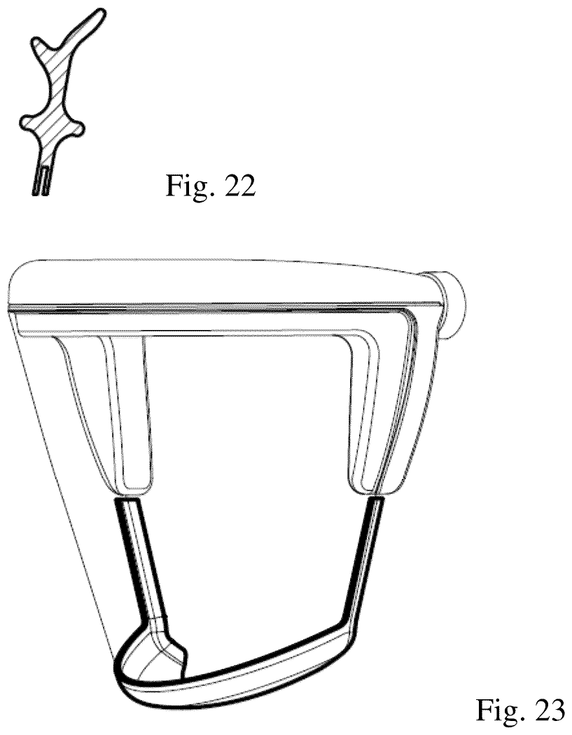

The exemplary band holder is curved in the x-z plane and in the direction of the y-axis. As shown in FIG. 8, it can be designed as a kind of spherical wedge shape or, as in the other examples, as a lip. The band holder, and in particular the lip, can have a notch that allows the band holder to be attached to the visor. Depending on the application, the lip can be curved and shaped in a different manner. A band holder with a Y-shaped cross-section, as shown in FIG. 19, or a branched cross-section, as shown in FIG. 22, may be used.

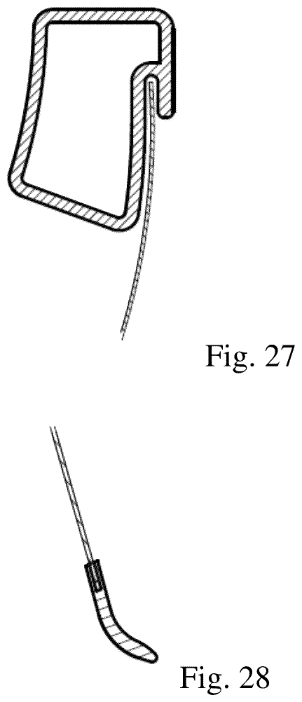

FIG. 27 shows how an exemplary visor can be inserted into an extended portion if an appropriate slot is provided in the extended portion.

Fluid mechanics tests have shown that air vortices may be created by flow separation at the edge of the visor. As a result, external air is drawn behind the visor, into an area 18 which corresponds to the space between the wearer's face and the visor. In order to prevent this, the cleaned air flow from the head support can be greatly increased. However, particularly large filters and powerful, large fans can endanger the eyes of the wearer as a result of an excessive airflow.

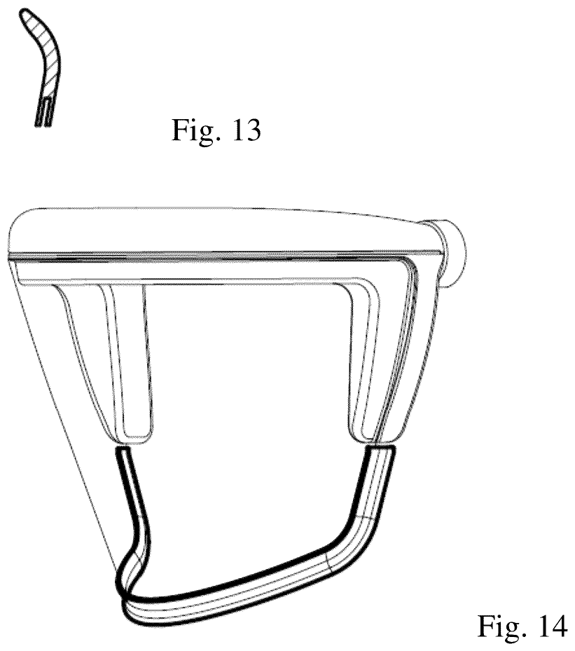

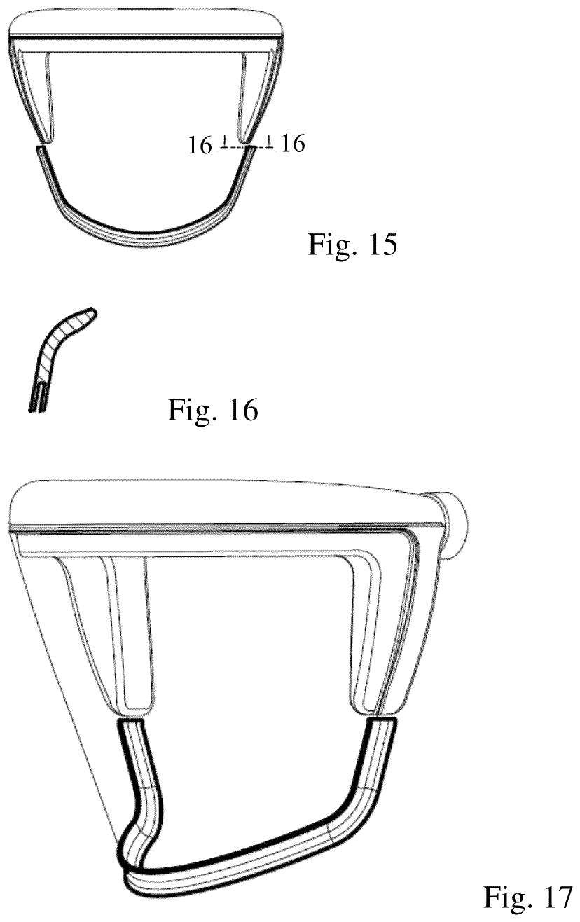

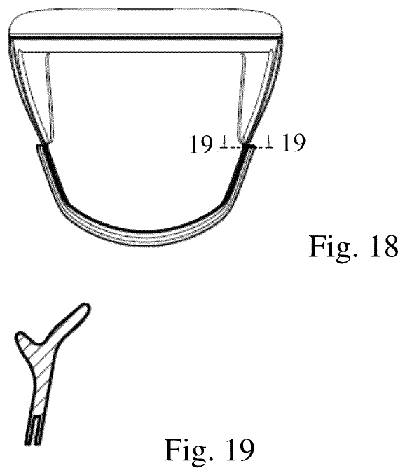

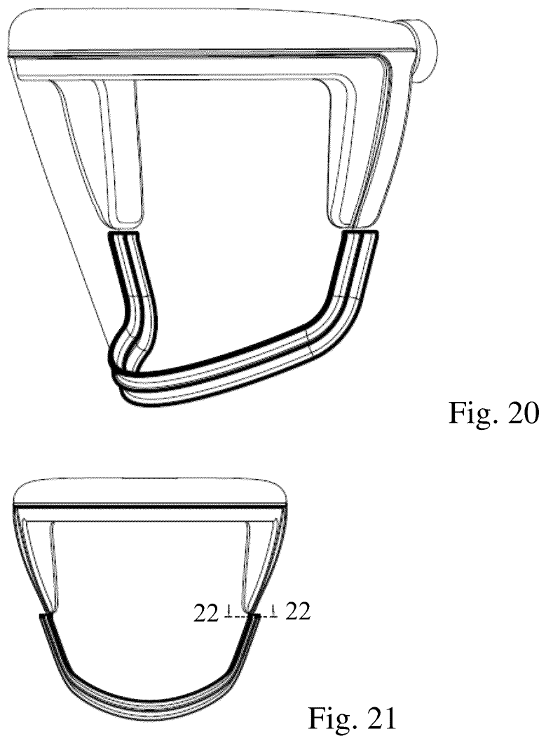

For this reason, in the other example arrangements, and in particular an arrangement shown in FIG. 13, the internal airflow is deflected in the direction of the wearer's face 19 by means of an edge along the lower lip or edge of the visor (furthest in the y-axis direction) that is inwardly curved towards the face. These flow-deflecting edges are also known as winglets. The deflection of the airflow by the winglet has the effect of slowing down the airflow on the inner visor surface. This increases the static pressure of the cleaned air on the winglet in the area 18, which is alternatively referred to herein as a region, between the visor and the wearer's face 19. The resulting difference in static pressure in front of and behind the visor (low in front of the visor, high behind the visor) prevents uncleaned air from flowing behind the visor and thus in front of the mouth and nose of the wearer.

Alternatively, as shown in FIG. 16, the outer, contaminated airflow can be diverted outwards away from the face at the edge or lip of the visor by means of a winglet. This also makes it more difficult for contaminated air to enter in the direction of the area between the visor and the face, since the dynamic air flow is thereby diverted away from the winglet.

In some arrangements a combination of the above described winglets combines both operating principles and optimizes the air flow at the edge of the visor—as shown in FIG. 19. In the case of laminar flow the pressure difference and deflection of the air flow can thus prevent contaminated air from entering the area between the visor and the user's face, and at the same time can maintain the cleaned air more effectively in the area between the visor and the face.

As a combination of laminar and turbulent flow will usually prevail at the lower leading edge of the visor below the front portion, it may be necessary to enhance the two operating principles described above. By arranging two or more winglets in a row on the inside and outside, types of “trapping chambers” for the flow are created (see FIG. 22). In these chambers the kinetic energy of the turbulent flow is slowed down. This is to ensure that the higher static pressure behind the visor plus the kinetic energy of the outflowing, cleaned air is greater than the kinetic energy of the contaminated air that would otherwise enter the area 18 from the outside environment.

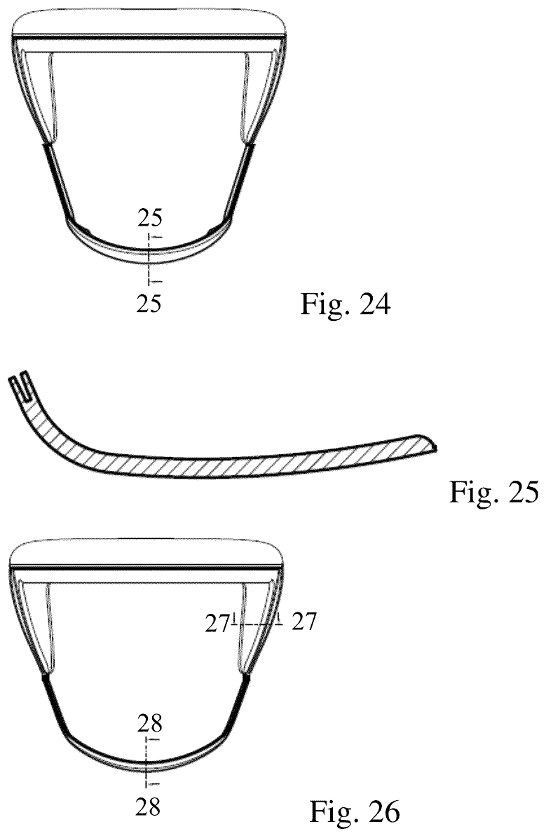

Due to the design shown in FIG. 22, however, there may be an air gap in the region of the wearer's chin. A further exemplary configuration of the winglet, which is shown in FIGS. 23 to 25, provides for the winglet to be widened by a shape in the form of a trough in the region of the wearer's chin in order to reduce the gap at the chin. The inner and outer winglets, which are shown in FIGS. 13, 16, 19 and 22, can also be retained in this configuration.

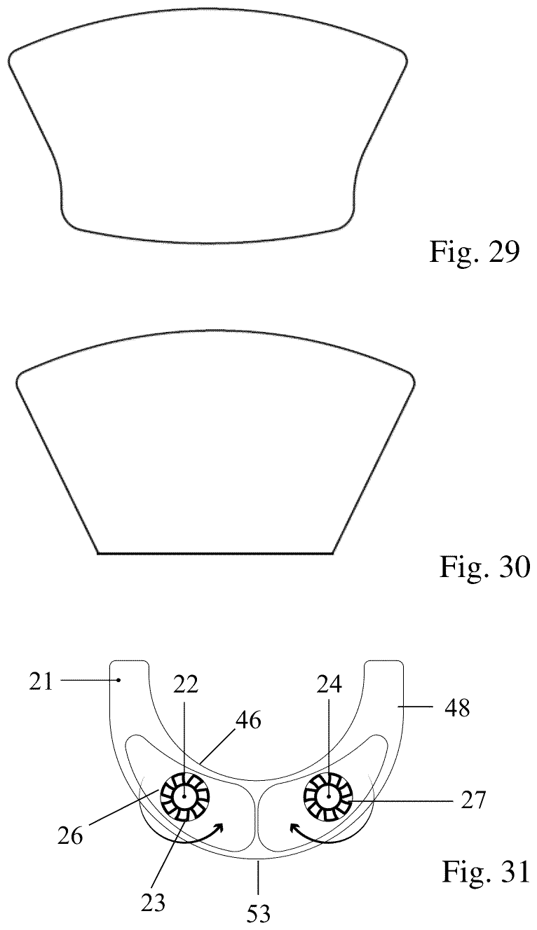

In exemplary arrangements the attachment structure of the visor includes a bead. The latter is preferably located both in the head support and also in the peripheral edge and the chin piece. As the peripheral visor edge can also be connected to the head support via a click or bayonet fastening, the originally planar flat visor is integrated into the overall apparatus and attached in a shaped manner. The shape can also be influenced by the peripheral visor edge and permits not only the special shape shown in FIG. 29, but also a simple shape of visor as shown in FIG. 30.

FIGS. 31 to 33 show how the exemplary flow pattern of the air after leaving the pair of motorized fans is determined by the direction of rotation of the at least one blade of the respective fans, and how this leads to an associated swirl of the air. The exemplary motorized fans are in attached connection with the head support 21 which serves as a headband, and are spaced apart from one another horizontally in the x-axis direction as shown when the head support is being worn.

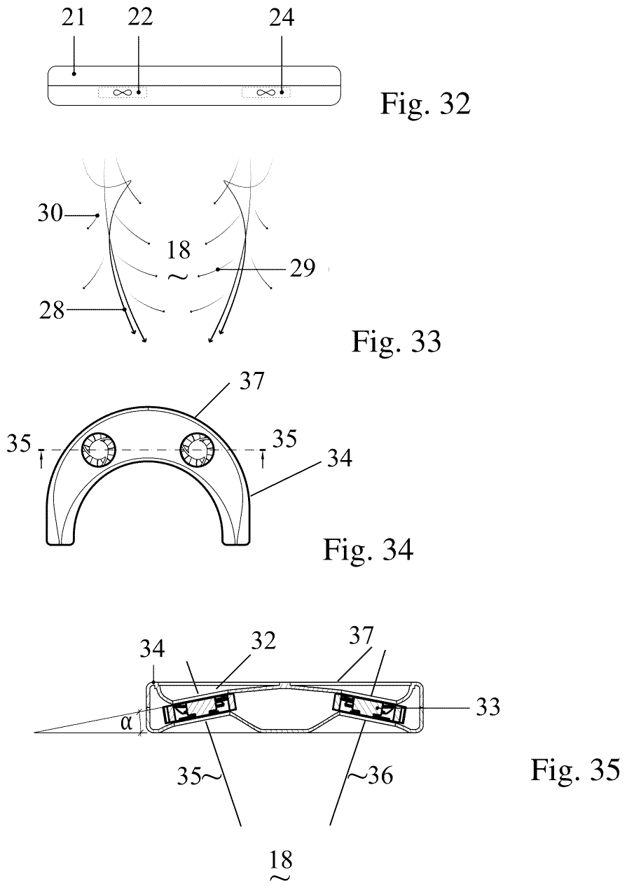

The greatest need for fresh air is in front of the wearer's face 19 at the mouth and nose, that is to say, in the exemplary arrangement centrally under the front portion 53 of the head support 21. Head support 21 is configured to be worn above the eyes 47 of the wearer and has a head accepting crescent shaped surface 46 that extends horizontally in an x-z plane as shown. The portions of the head support 21 extending transversely away from the front portion 53 correspond to branch portions like those on other exemplary arrangements, and like other exemplary arrangements may include extension portions extending therefrom. A face 48 extending on the head support from the crescent shape surface 46 faces in the y-axis direction which is upward in the operative position as shown. A motorized fan 22 has at least one anticlockwise rotating fan blade 23. A motorized fan 24 has at least one clockwise rotating fan blade 25. Each of fans 22 and 24 have an associated air intake 26, 27 that extends through the face 48. Each of the fans is installed in fixed operative connection the head support 21 as shown in FIGS. 31 and 32. The exemplary arrangement enables air flow in the area 18 in front of the face 19 to be improved. Due to the swirl and direction of concurrent fan blade rotation, the main direction of the air flow 28 is towards the center of the visor, and therefore in the area 18 in front of the mouth and the nose of a wearer's face 19.

The excess air provided by fans to the area can keep contaminated ambient air away from the lower region of the visor so that contaminated air does not flow into the area 18 as shown in FIG. 33. The swirl imparted by the rotating fan blades causes further, smaller air flows separately to occur, which are both directed inwards 29, and thus supply the area including the wearer's nose and mouth region with cleaned air, as well as air flowing outwards 30.

In particular, the outwardly directed flow 30 prevents contaminated air from entering the area from the side. This effect can, on the one hand, be created by the different directions of rotation of the fans, or in other ways, such as by air guidance constructs at the outlets of the fans.

As already described, the greatest need for fresh air is centrally in the area in front of the wearer's mouth and nose. This region may therefore be supplied with a directed air flow. If fans with different directions of blade rotation are not installed or insufficient, a central directed air flow 31 in the area can alternatively or additionally be achieved by positioning motorized fans 32, 33 in an alternative head support 34 which serves as a headband, at an angle alpha of between 0° and 20° as shown in FIG. 35. As a result, the respective axes of rotation 35, 36 of the at least one fan blade of the respective fans 32, 33 may be convergent in the y-axis direction (downward) away from the front portion 37 of the head support 34 in the area between the visor and wearer's face. This is shown in FIGS. 34 to 36.

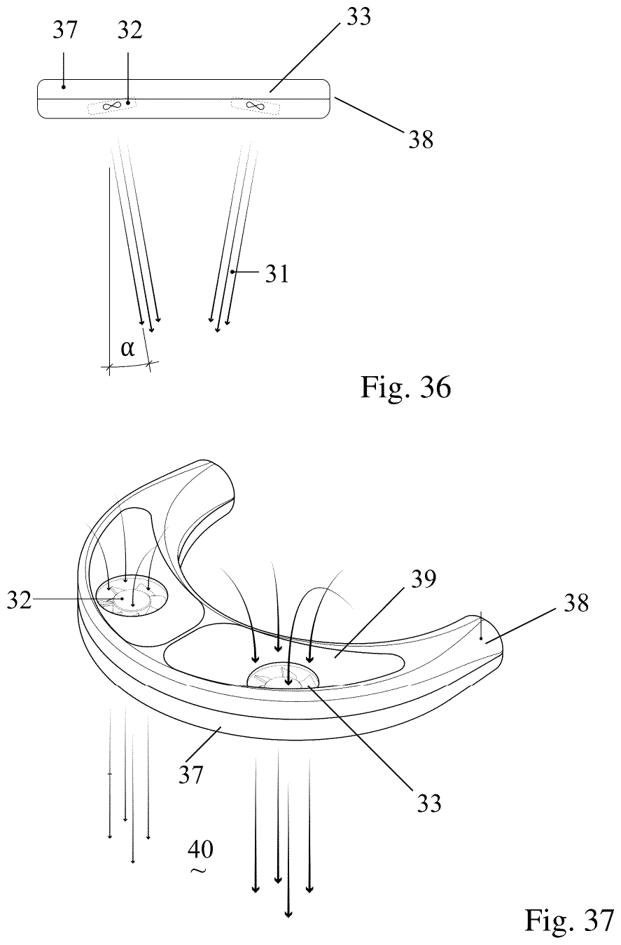

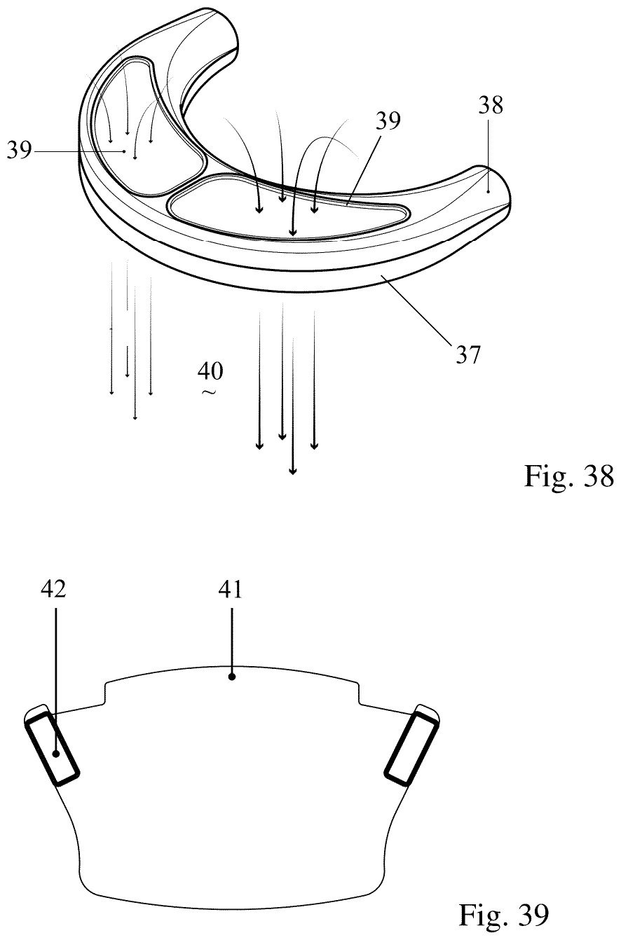

The basic path of the air is from top to bottom through the alternative headband 38, as shown in FIGS. 37 and 38. The fans 32, 33 are installed horizontally disposed in the front portion 37 of the headband 38. The air is sucked in from above the headband 38 through an air intake, cleaned by means of a replaceable filter membrane which is alternatively referred to as an air filter 39, and blown out of the headband downwards to an area 40 in front of a wearer's face.

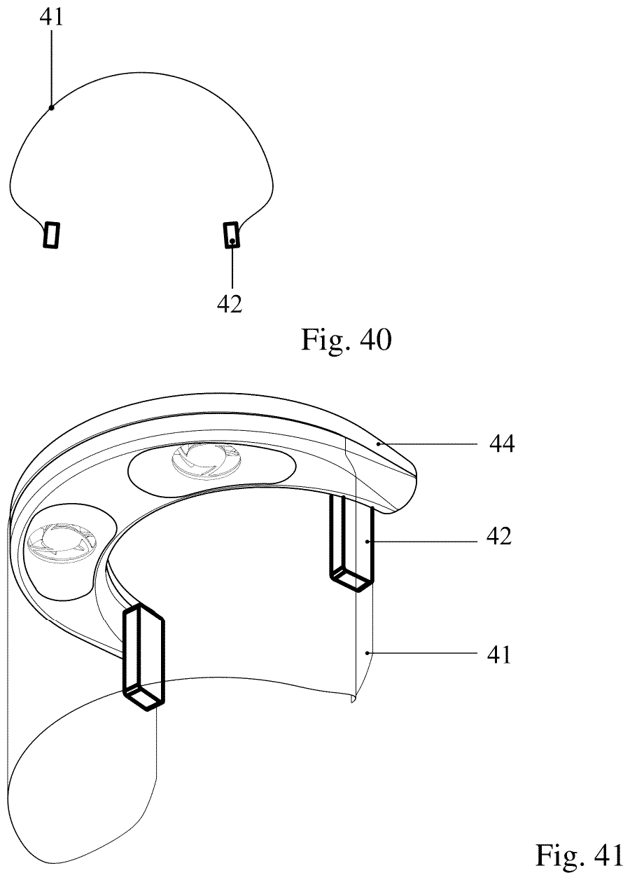

The mounting of a visor 41 on the headband 34, 38 or other exemplary head support 44 which serves as headband leads to a natural curvature of the visor, as shown in FIGS. 39 to 41. Although the curvature improves the airflow situation, it also contributes to the sound level of the fans and the airflow being directed outwards towards the ears.

An exemplary seal 42 is shown in FIGS. 39 to 41 as a barrier for sound, and also for air entering the area from the outside environment. This is mounted on the inside of the visor 41. It interrupts the sound transmission and prevents any cross-contamination by the entry of contaminated air from behind.

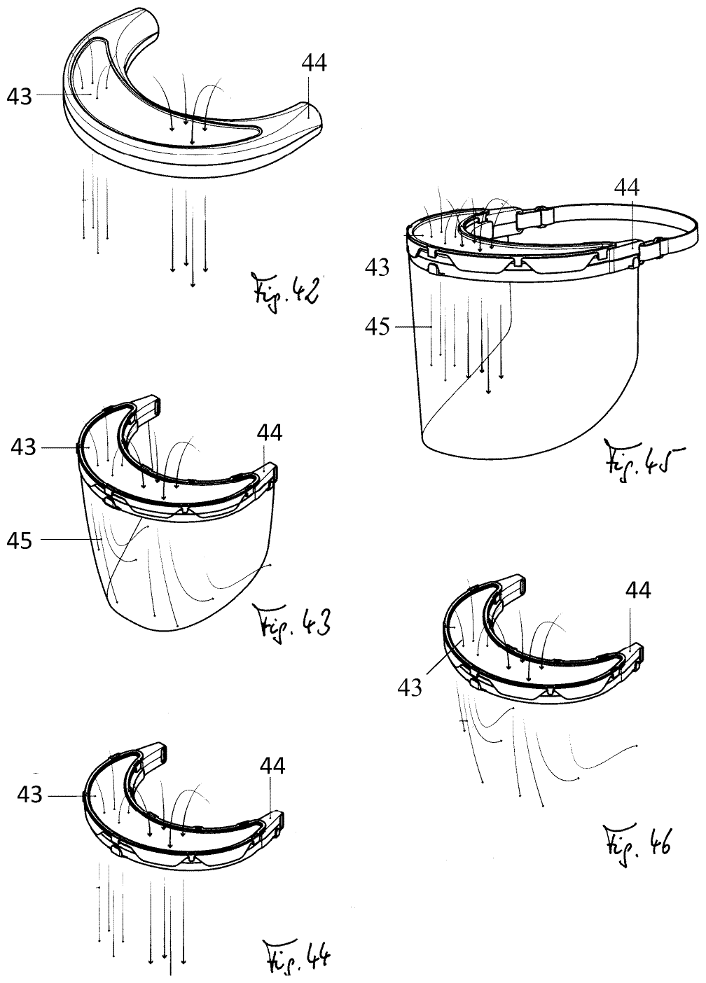

FIGS. 42 to 46 show similar exemplary arrangements. A crescent-shaped filter 43 is provided on the upper face of the exemplary headband 44, through which the air flows. FIG. 42 is labelled with arrows representing air entering and air flowing out of the headband. This air flows at right angles to the filter 43 and is only slightly deflected by the visor 45.

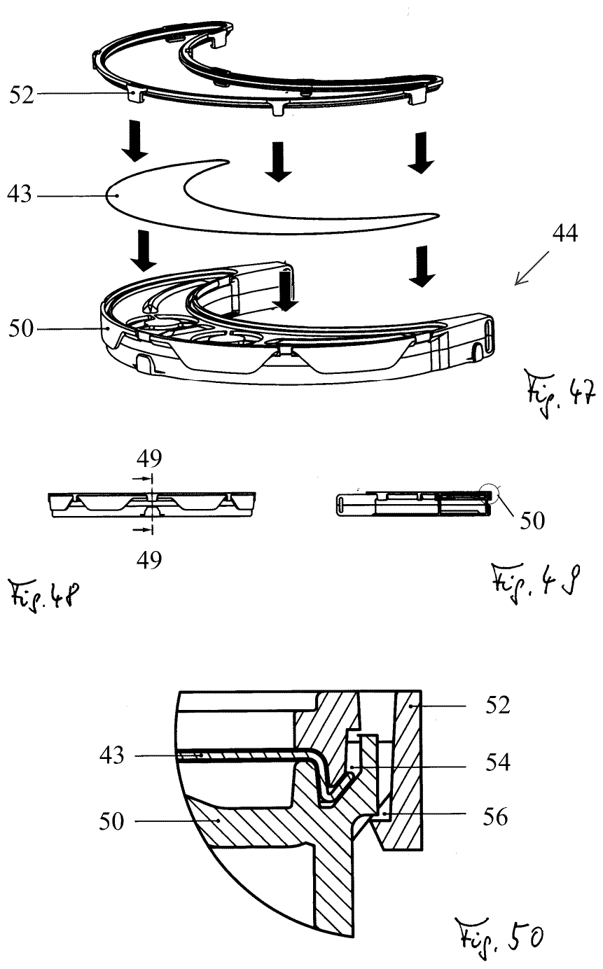

FIGS. 47 to 50 also show exemplary parts associated with the headband 44. The headband 44 already shown in FIGS. 42 to 46 includes a lower part 50, the filter 43 and an upper part 52. The filter 43 is clamped in a space 54 between the lower part 50 and the upper part 52, and the upper part is hooked onto the lower part at 56 so as to hold the parts together.

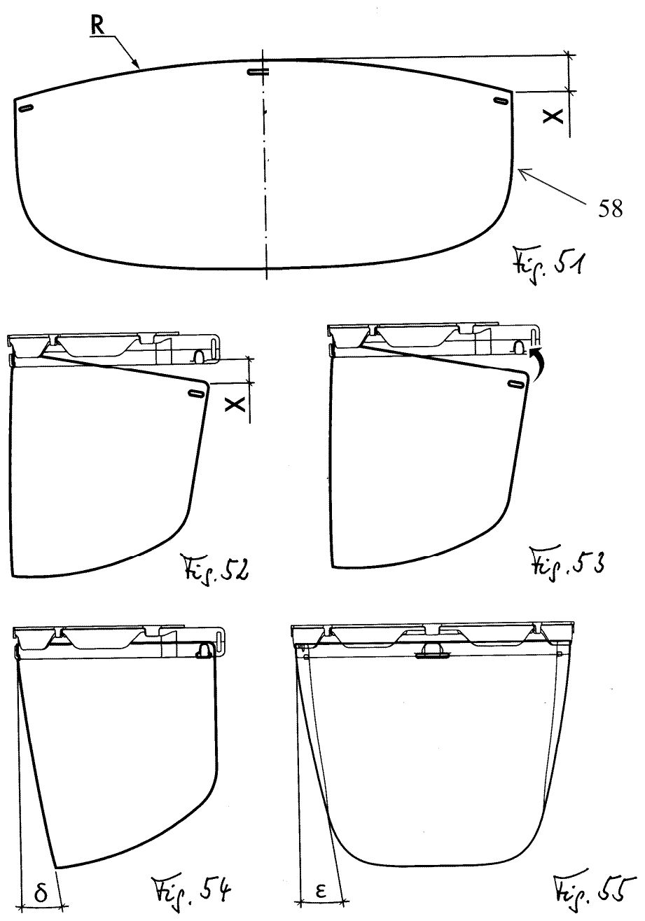

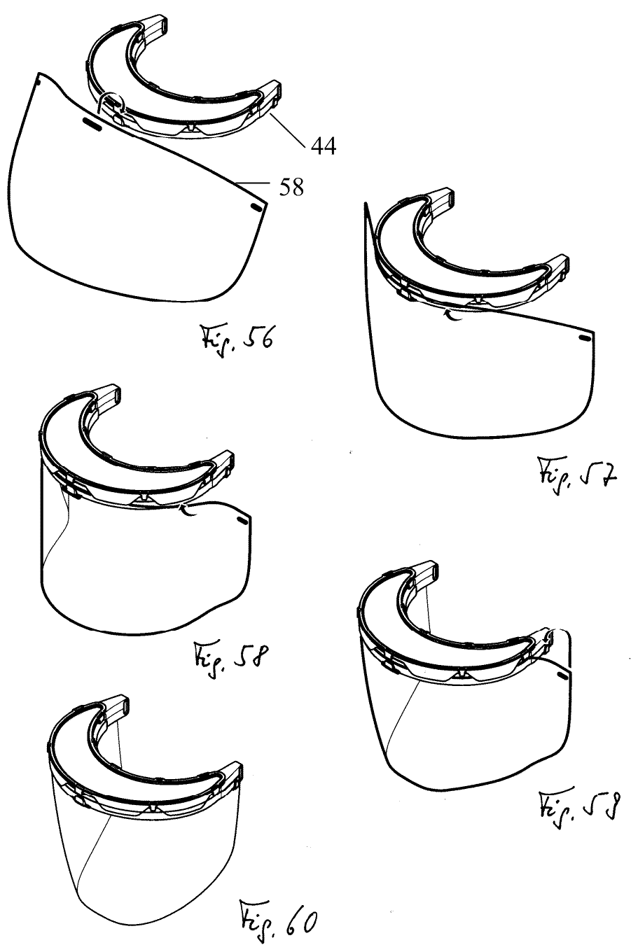

A specially shaped visor 58 is shown in FIGS. 51 to 55. It has an upper face with a curved edge R, and is manufactured as a planar flat surface. If this visor is now placed against the U-shaped curved line of the headband, the visor is shaped and an angle δ is created between a line at right angles to the headband and the visor in the center of the visor. On the sides of the visor, an angle ε is created between a line at right angles to the headband and the visor. The exemplary angles δ and ε are between 5 and 15 degrees, and may be at about 10 degrees, so as to direct the air flowing down from above the headband towards the wearer's face. In exemplary arrangements the visor 58 is attached to the headband such that the air entering from above can exit without resistance in the lower region of the visor.

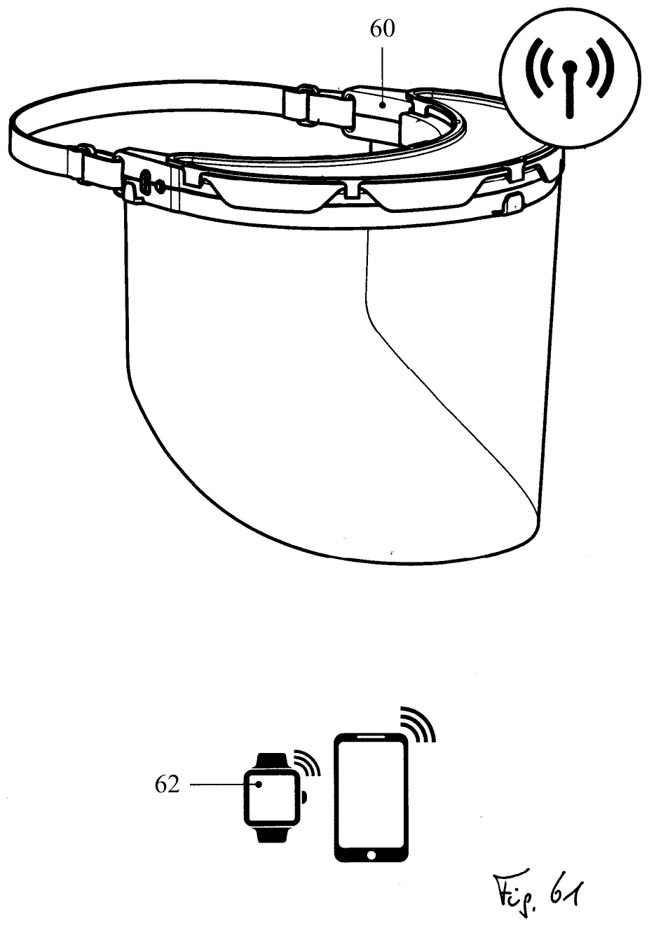

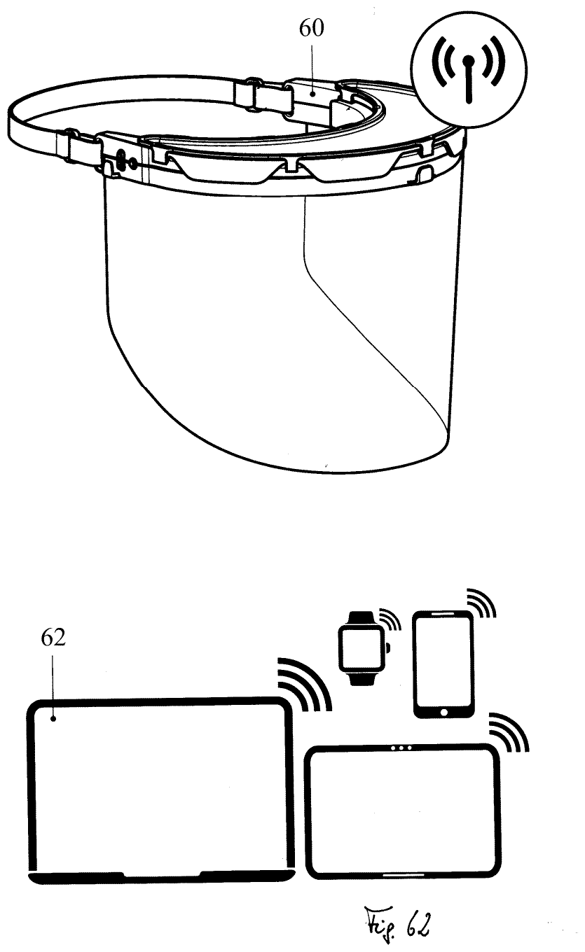

FIGS. 56 to 60 show how the exemplary visor 58 can be attached to an exemplary headband 44 with just a few hooks and, in the exemplary arrangement, with just 3 hooks. For this purpose, the lower part of the headband is made from two injection molded parts that are joined together. One of these has a central hook on the lower element of the lower part of the headband, which is inserted into an opening on the visor. The visor can then be curved and inserted under the contact surfaces of the upper element of the lower part of the headband. Finally, the visor is curved to such an extent that openings provided on the side of the visor can be hooked into hooks on the lower element of the lower part of the headband on the sides of the headband. The visor is thus securely fastened between the contact surfaces of the upper element of the lower part of the headband and hooks on the lower element of the lower part of the headband.

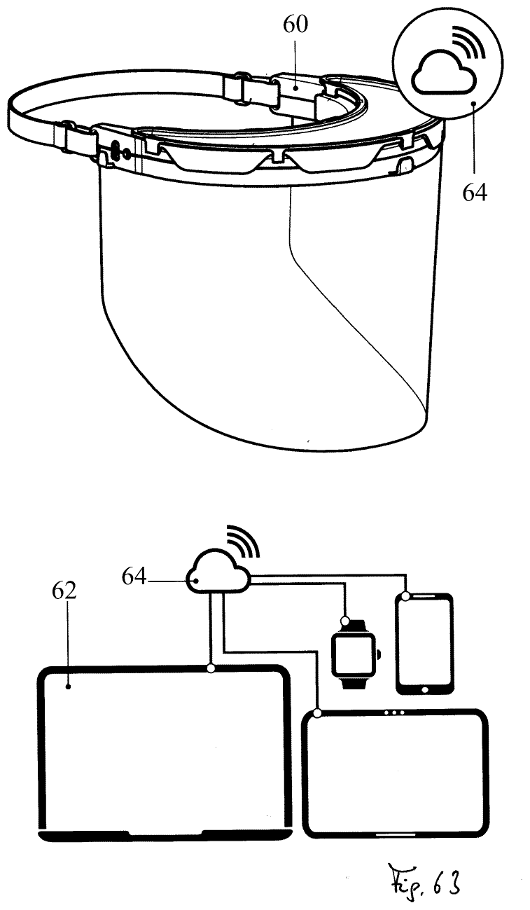

FIGS. 61 to 63 represent how a wireless transmitter 60, which can preferably also serve as a receiver (a transceiver), can be operatively connected to fixed or mobile devices 62, such as electronic watches, mobile phones, laptops, or even directly or indirectly to a network cloud 64. This makes it possible to record and evaluate the data on the use of the head support directly in the head support, and/or to collect and evaluate it at a control center.

Thus the exemplary arrangements achieve improved operation, eliminate difficulties encountered in the use of prior devices and arrangements, and attain the useful results described herein.

In the foregoing description, certain terms have been used for brevity, clarity and understanding. However no unnecessary limitations are to be implied therefrom because such terms are used for descriptive purposes and are intended to be broadly construed. Moreover the descriptions and illustrations herein are by way of examples and the new and useful features and relationships are not limited to the exact features that have been shown and described.

It should be understood that the features and/or relationships associated with one exemplary arrangement can be combined with features and/or relationships from another exemplary arrangement. That is, various features and/or relationships from various arrangements can be combined in further arrangements. The new and useful scope of the disclosure is not limited only to the exact arrangements that have been shown and described.

Having described features, discoveries and principles of the exemplary arrangements, the manner in which they are constructed and operated, and the advantages and useful results attained, the new and useful features, devices, elements, arrangements, parts, combinations, systems, equipment, operations, methods, processes and relationships are set forth in the appended claims.

1-19. (canceled)

20. Apparatus comprising:
a head support including
a transparent visor, and
a headband, wherein the headband includes
a front portion, wherein the front portion extends in an x-axis direction, wherein the visor extends in the x-axis direction across the front portion,
a pair of branch portions, wherein each branch portion
is disposed away in the x-axis direction from the other branch portion,
extends away from the front portion in a z-axis direction that is perpendicular to the x-axis direction,
a pair of extension portions, wherein each extension portion
extends away from a respective branch portion in a y-axis direction that is perpendicular to each of the x-axis direction and the z-axis direction,
includes a contact surface portion, wherein each contact surface portion is in attached connection with the visor,
a pair of motorized fans, wherein each fan
is in operatively attached connection with the headband,
includes at least one respective rotatable fan blade,
is disposed in the x-axis direction from the other fan,
is configured to cause air to move in an area that is disposed in the z axis direction from the visor and the y-axis direction from the headband,
wherein the respective at least one fan blade of one fan of the pair is operative to rotate in a clockwise direction concurrently while the respective at least one fan blade of the other fan of the pair is operative rotate in an anticlockwise direction.

21. The apparatus according to claim 20
wherein at least one of the extension portions includes a cavity,
wherein the cavity includes at least one of an electronic component and an air filter.

22. The apparatus according to claim 20
wherein at least one of the extension portions includes at least one of an electronic component and an air filter.

23. The apparatus according to claim 20
wherein at least one of the extension portions includes a cushion,
wherein the cushion extends in facing relation with the other extension portion.

24. The apparatus according to claim 20
wherein each of the extension portions includes a respective cushion,
wherein each cushion of a respective extension portion extends in facing relation with the respective cushion of the other extension portion,
wherein the cushions are configured to engage a head of a wearer of the head support.

25. The apparatus according to claim 20
wherein the visor includes a leading portion that is disposed furthest in the z-axis direction away from each of the extension portions,
wherein the leading portion extends at an angle of from 5° to 25° relative to the y-axis direction and is closer in the z-axis direction to each of the extension portions with increased distance the away from the front portion in the y-axis direction.

26. The apparatus according to claim 20
wherein the front portion is curved,
wherein the visor is curved in engagement with the front portion.

27. The apparatus according to claim 20
wherein each contact surface portion is bounded by a respective step,
wherein each respective step is in contact with the visor,
wherein each respective step is configured to provide an air seal between the respective extension portion and the visor.

28. The apparatus according to claim 20
wherein the visor is releasably attached to the headband,
wherein the visor is flexible and is configured to lie flat in a single plane when disengaged from the headband.

29. The apparatus according to claim 20
wherein the headband includes a crescent shape surface, wherein the crescent shape surface extends in a plane, wherein the plane extends in the x-axis direction and the z-axis direction,
wherein the crescent shape surface includes a face, wherein the face faces in the y-axis direction and away from the area,
wherein the face includes a pair of air intakes, wherein the air intakes are disposed from one another in the x-axis direction,
wherein a respective fan is operative to cause air to be drawn in the y-axis direction through a respective air intake.

30. The apparatus according to claim 20
wherein the headband includes a crescent shape surface, wherein the crescent shape surface extends in a plane, wherein the plane extends in the x-axis direction and the z-axis direction,
wherein the crescent shape surface includes a face, wherein the face faces in the y-axis direction and away from the area,
wherein the face includes at least one air intake,
wherein at least one of the pair of fans is operative to cause air to be drawn through the at least one air intake.

31. The apparatus according to claim 20
wherein the headband includes a crescent shape surface, wherein the crescent shape surface extends in a plane, wherein the plane extends in the x-axis direction and the z-axis direction,
wherein the crescent shape surface includes a face, wherein the face faces in the y-axis direction and away from the area,
wherein the face includes a crescent shape air intake,
wherein at least one of the pair of fans is operative to cause air to be drawn through the crescent shape air intake.

32. the apparatus according to claim 20
wherein the respective at least one blade of each respective fan is rotatable about a respective axis,
wherein the axes of the pair of fans are convergent in the y-axis direction in the area.

33. The apparatus according to claim 20
wherein the pair of fans are operative to draw air in the y-axis direction and into the area.

34. The apparatus according to claim 20
wherein the visor is bounded in the y-axis direction away from the headband direction by a lip,
wherein the visor includes a winglet adjacent to the lip,
wherein the winglet is operative to resist air movement around the lip into the area.

35. The apparatus according to claim 20
wherein the visor is bounded in the y-axis direction away from the headband by a lip,
wherein the lip extends continuously between the respective contact surface portions of each extension portion,
wherein the lip has positioned adjacent thereto a winglet, wherein the winglet extends continuously between the respective contact surface portions of each extension portion,
wherein the winglet is operative to resist air movement around the lip and into the area.

36. The apparatus according to claim 20
wherein the headband includes at least one air filter, wherein the pair of fans is operative to cause air to be drawn through the at least one air filter.

37. The apparatus according to claim 20
wherein each of the extension portions
has a length in the y-axis direction between 3 cm and 20 cm,
has a width in the z-axis direction between 0.2 cm and 6 cm, and
has a depth in the x-axis direction between 0.5 cm and 8 cm.

38. Apparatus comprising:
a head support including
a visor, and
headband, wherein the headband includes
a curved front portion, wherein in the front portion is configured such that in an operative position of the head support, the front portion extends above the eyes of a face of a wearer of the head support,
a pair of branch portions, wherein each branch portion extends
transversely and horizontally away from the front portion in the operative position,
in parallel relation with the other branch portion of the pair,
wherein in the operative position, each branch portion is configured to extend on a respective side of the face of the wearer,
a pair of extension portions, wherein each extension portion
in the operative position extends downward away from a respective branch portion on a respective side of the face of the wearer,
includes a respective contact surface portion,
wherein the visor extends in operative engagement with the front portion and each contact surface portion, such that in the operative position the visor extends in front of the face of the wearer such that an area extends between the face of the wearer and the visor,
a pair motorized fans, wherein each fan
is in operatively attached connection with the headband,
includes at least one respective rotatable fan blade,
in the operative position is disposed horizontally away from the other fan, and
is operative to cause air to be moved through the headband and the area between the face of the wearer and the visor,
wherein the respective at least one fan blade of one fan of the pair is operative to rotate in a clockwise direction concurrently while the respective at least one fan blade of the other fan of the pair is operative to rotate in an anticlockwise direction.

39. The apparatus according to claim 38:
wherein the respective at least one fan blade of a respective fan is rotatable about a respective axis,
wherein the axes are convergent in a downward direction from the headband.
